(19) United States
(12) Patent Application Publication
(10) Pub. No.: US 2006/0058979 A1
(43) Pub. Date: Mar. 16, 2006

(54) Method and system for calibrating integrated metrology systems and stand-alone metrology systems that acquire wafer state data

(76) Inventors: Richard J. Markle, Austin, TX (US); Kevin R. Lensing, Austin, TX (US); Christopher A. Bode, Austin, TX (US)

Correspondence Address: WILLIAMS, MORGAN & AMERSON, 10333 RICHMOND, SUITE 1100, HOUSTON, TX, 77042, US

(21) Appl. No.: 10/940,369

(22) Filed: Sep. 14, 2004

(51) Int. Cl. G01B 15/00

(52) U.S. Cl. 702/155

(57) ABSTRACT

The present invention is directed to methods and systems for calibrating integrated metrology systems and stand-alone metrology systems that acquire wafer state data. In one illustrative embodiment, the method includes providing a plurality of process tools, each of the process tools comprising an integrated metrology system adapted to obtain wafer state data, and providing a plurality of stand-alone metrology tools, each of which are adapted to obtain wafer state data. The method further comprises processing at least one wafer through each of the process tools and each of the stand-alone metrology tools, wherein wafer state data for at least one wafer is acquired in each of the process tools and in each of the stand-alone metrology tools, and calibrating the integrated metrology system in at least one of the process tools or at least one of the stand-alone metrology tools based upon the wafer state data acquired for the wafer.

### BACKGROUND OF THE INVENTION

1. Field of the Invention

This invention relates generally to metrology processes, and, more particularly, to various methods and systems for calibrating integrated metrology systems and stand-alone metrology systems that acquire wafer state data.

2. Description of the Related Art

There is a constant drive within the semiconductor industry to increase the quality, reliability and throughput of integrated circuit devices, e.g., microprocessors, memory devices, and the like. This drive is fueled by consumer demands for higher quality computers and electronic devices that operate more reliably. These demands have resulted in a continual improvement in the manufacture of semiconductor devices, e.g., transistors, as well as in the manufacture of integrated circuit devices incorporating such transistors. Additionally, reducing the defects in the manufacture of the components of a typical transistor also lowers the overall cost per transistor as well as the cost of integrated circuit devices incorporating such transistors.

Generally, a set of processing steps is performed on a lot of wafers using a variety of process tools, including photolithography steppers, etch tools, deposition tools, polishing tools, thermal anneal process tools, implantation tools, etc. The technologies underlying semiconductor process tools have attracted increased attention over the last several years, resulting in substantial refinements. However, despite the advances made in this area, many of the process tools that are currently commercially available suffer certain deficiencies. In particular, some of such tools often lack advanced process data monitoring capabilities, such as the ability to provide historical parametric data in a user-friendly format, as well as event logging, real-time graphical display of both current processing parameters and the processing parameters of the entire run, and remote, i.e., local site and worldwide, monitoring. These deficiencies can engender non-optimal control of critical processing parameters, such as throughput, accuracy, stability and repeatability, processing temperatures, mechanical tool parameters, and the like. This variability manifests itself as within-run disparities, run-to-run disparities and tool-to-tool disparities that can propagate into deviations in product quality and performance, whereas an ideal monitoring and diagnostics system for such tools would provide a means of monitoring this variability, as well as providing means for optimizing control of critical parameters.

One technique for improving the operation of a semiconductor processing line includes using a factory wide control system to automatically control the operation of the various process tools. The manufacturing tools communicate with a manufacturing framework or a network of processing modules. Each manufacturing tool is generally connected to an equipment interface. The equipment interface is connected to a machine interface that facilitates communications between the manufacturing tool and the manufacturing framework. The machine interface can generally be part of an advanced process control (APC) system. The APC system initiates a control script based upon a manufacturing model, which can be a software program that automatically retrieves the data needed to execute a manufacturing process. Often, semiconductor devices are staged through multiple manufacturing tools for multiple processes, generating data relating to the quality of the processed semiconductor devices.

During the fabrication process various events may take place that may affect the performance of the devices being fabricated. That is, variations in the fabrication process steps may result in device performance variations. Factors, such as feature critical dimensions, doping levels, contact resistance, particle contamination, etc., all may potentially affect the end performance of the device. Various tools in the processing line are controlled in accordance with performance models to reduce processing variation. Commonly controlled tools include photolithography steppers, polishing tools, etching tools, and deposition tools. Pre-processing and/or post-processing metrology data is supplied to process controllers for the tools. Operating recipe parameters, such as processing time, are calculated by the process controllers based on the performance model and the metrology information to attempt to achieve post-processing results as close to a target value as possible. Reducing variation in this manner leads to increased throughput, reduced cost, higher device performance, etc., all of which equate to increased profitability.

Target values for the various processes performed are generally based on design values for the devices being fabricated. For example, a particular process layer may have a target thickness. Operating recipes for deposition tools and/or polishing tools may be automatically controlled to reduce variation about the target thickness. In another example, the critical dimensions of a transistor gate electrode may have an associated target value. The operating recipes of photolithography tools and/or etch tools may be automatically controlled to achieve the target critical dimensions.

Typically, a control model is used to generate control actions for changing the operating recipe settings for a tool being controlled based on feedback or feedforward metrology data collected related to the processing by the tool. To function effectively, a control model must be provided with metrology data in a timely manner and at a quantity sufficient to maintain its ability to predict the future operation of the tool it controls.

Within many manufacturing industries, great effort is made to insure that processing operations are performed accurately such that the resulting device meets target specifications. This is particularly true within the semiconductor manufacturing industry wherein vast amounts of metrology data regarding the state of a wafer, i.e., wafer state data, is obtained at many points throughout the fabrication process in an effort to insure that the resulting integrated circuit device complies with product specifications. In general, wafer state data may be understood to be any type of metrology data that relates to the physical state or characteristics of the wafer itself, or layers or features formed thereon. For example, wafer state data may include variables such as film thickness, the critical dimension or profile of features formed above or in the wafer, the surface roughness of the wafer or a layer formed thereabove, the temperature of the wafer, the surface planarity of the wafer, optical properties and/or chemical composition of a film, as well as the quantity, size, and/or type of defects or irregularities found on a wafer, etc.

Traditionally, wafer state data is acquired using a variety of stand-alone metrology tools. After processing operations progress to a certain point, wafers, e.g., a wafer lot, are typically sent to a metrology bay within a manufacturing facility that is comprised of a plurality of stand-alone metrology tools. Depending upon the particular metrology operation desired, and the availability of the metrology tools, the wafers are then processed in one or more of the stand-alone metrology tools to acquire the desired wafer state metrology data. Thereafter, additional process operations are performed on the wafers. This process was repeated several times during the life cycle of a typical wafer as it progressed throughout the fabrication facility. In recent years, process tools have been provided with integrated metrology systems resident on the tool. Such integrated metrology systems can take a variety of forms, e.g., independent metrology chambers within a process tool and/or sensors adapted to obtain wafer state data about the wafer as it is processed in or through the process tool. For example, a process tool may comprise a plurality of sensors positioned in a wafer staging or transport area wherein the sensors are adapted to obtain wafer state data regarding a process operation performed in the tool on the wafer, e.g., film thickness.

As indicated previously, it is critically important in the manufacture of integrated circuit devices that the devices be formed to very precise dimensions such that the resulting device will perform as intended. Thus, efforts must be taken to insure that the voluminous amounts of wafer state data obtained from various metrology sources, e.g., integrated metrology systems and stand-alone metrology tools, are valid and accurately reflect the true state of the wafer. In a worst-case scenario, relying on erroneous wafer state metrology data from one or more metrology sources may lead to taking unnecessary corrective actions, and/or unnecessary rework, all of which may lead to reduced productivity and increased costs.

The present invention is directed to overcoming, or at least reducing the effects of, one or more of the problems set forth above.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is generally directed to various methods and systems for calibrating integrated metrology systems and stand-alone metrology systems that acquire wafer state data. In one illustrative embodiment, the method comprises providing a plurality of process tools, each of the process tools comprising an integrated metrology system adapted to obtain wafer state data, and providing a plurality of stand-alone metrology tools, each of which are adapted to obtain wafer state data. The method further comprises processing at least one wafer through each of the plurality of process tools and through each of the plurality of stand-alone metrology tools, wherein wafer state data for at least one wafer is acquired in each of the plurality of process tools and in each of the plurality of stand-alone metrology tools, and calibrating the integrated metrology system in at least one of the plurality of process tools or at least one of the plurality of stand-alone metrology tools based upon the wafer state data acquired for the at least one wafer. In further embodiments, the method comprises processing a plurality of additional wafers through at least one of the plurality of tools and/or stand-alone metrology tools after the step of calibrating the integrated metrology systems and/or stand-alone process tools based upon the acquired wafer state data has been performed.

In another illustrative embodiment, the method comprises providing a plurality of process tools, each of the process tools comprising an integrated metrology system adapted to obtain wafer state data, providing a plurality of stand-alone metrology tools, each of which are adapted to obtain wafer state data, processing at least one wafer through each of the plurality of process tools and through each of the plurality of stand-alone metrology tools, wherein wafer state data for at least one wafer is acquired in each of the plurality of process tools and in each of the plurality of stand-alone metrology tools, and providing a controller adapted to access the wafer state data acquired for the at least one wafer and perform the step of calibrating the integrated metrology system in at least one of the plurality of process tools or at least one of the plurality of stand-alone metrology tools based upon the wafer state data acquired for the at least one wafer.

In yet another illustrative embodiment, the method comprises providing a plurality of process tools, each of the process tools comprising an integrated metrology system adapted to obtain wafer state data, providing a plurality of stand-alone metrology tools, each of which are adapted to obtain wafer state data, providing a controller adapted to identify wafer state data obtained from one of the integrated metrology systems and the stand-alone metrology tools as reference wafer state data, and processing at least one wafer through each of the plurality of process tools and through each of the plurality of stand-alone metrology tools, wherein wafer state data for the at least one wafer is acquired in each of the plurality of process tools and in each of the plurality of stand-alone metrology tools, and wherein the controller is adapted to access the acquired wafer state data and perform the step of calibrating the integrated metrology system in at least one of the plurality of process tools or at least one of the plurality of stand-alone metrology tools based upon a variance between the wafer state data acquired for the at least one wafer and the reference wafer state data.

### BRIEF DESCRIPTION OF THE DRAWINGS

The invention may be understood by reference to the following description taken in conjunction with the accompanying drawings, in which like reference numerals identify like elements, and in which:

FIG. 1 is a simplified block diagram of a manufacturing system in accordance with one illustrative embodiment of the present invention;

FIG. 2 is a simplified block diagram of a more detailed depiction of an automated calibration system in accordance with one illustrative embodiment of the present invention;

FIG. 3 is a simplified block diagram of an illustrative tool that may be employed with the present invention; and

FIG. 4 is a simplified flow diagram of a method of calibrating integrated metrology systems and stand-alone metrology systems in accordance with one illustrative embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

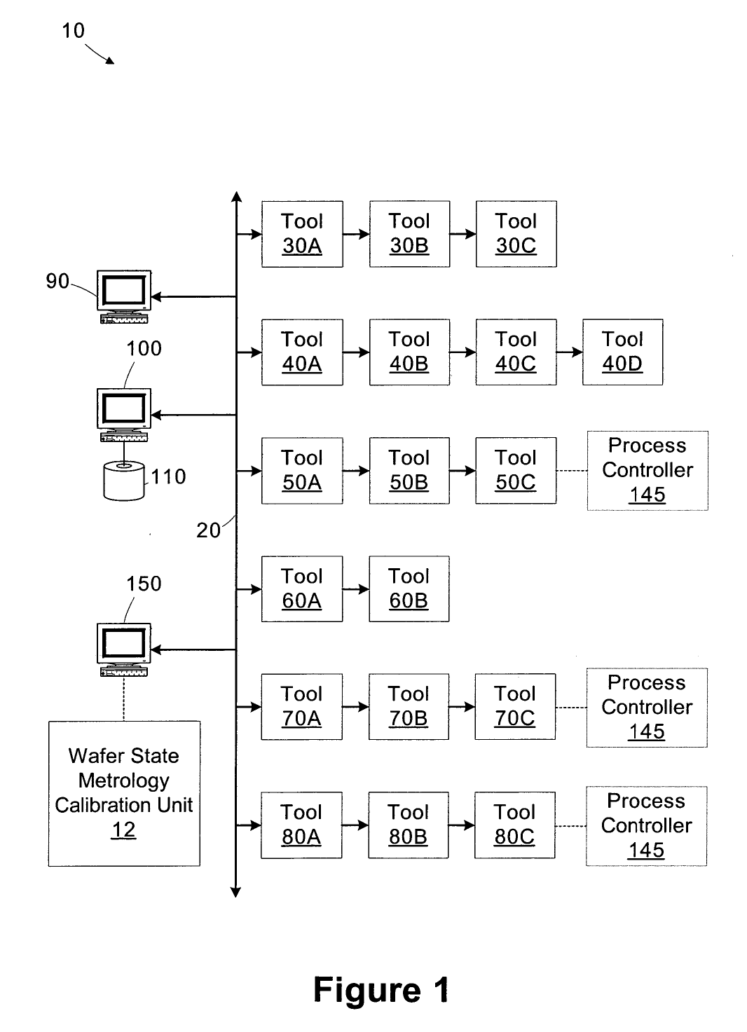

Referring to FIG. 1, a simplified block diagram of an illustrative manufacturing system 10 is provided. In the illustrated embodiment, the manufacturing system 10 is adapted to fabricate semiconductor devices. Although the invention is described as it may be implemented in a semiconductor fabrication facility, the invention is not so limited and may be applied to other manufacturing environments. The techniques described herein may be applied to a variety of workpieces or manufactured items, including, but not limited to, microprocessors, memory devices, digital signal processors, application specific integrated circuits (ASICs), or other devices. The techniques may also be applied to workpieces or manufactured items other than semiconductor devices.

A network 20 interconnects various components of the manufacturing system 10, allowing them to exchange information. The illustrative manufacturing system 10 includes a plurality of tools 30-80. Each of the tools 30-80 may be coupled to a computer (not shown) for interfacing with the network 20. The tools 30-80 are grouped into sets of like tools, as denoted by lettered suffixes. For example, the set of tools 30A-30C represent tools of a certain type, such as a chemical mechanical planarization tool. A particular wafer or lot of wafers progresses through the tools 30-80 as it is being manufactured, with each tool 30-80 performing a specific function in the process flow. Exemplary processing tools for a semiconductor device fabrication environment include metrology tools, photolithography steppers, etch tools, deposition tools, polishing tools, rapid thermal anneal tools, implantation tools, etc. The tools 30-80 are illustrated in a rank and file grouping for illustrative purposes only. In an actual implementation, the tools 30-80 may be arranged in any physical order or grouping. Additionally, the connections between the tools in a particular grouping are meant to represent connections to the network 20, rather than interconnections between the tools 30-80.

A manufacturing execution system (MES) server or controller 90 directs high level operation of the manufacturing system 10. The MES server 90 may monitor the status of the various entities in the manufacturing system 10 (i.e., lots, tools 30-80) and control the flow of articles of manufacture (e.g., lots of semiconductor wafers) through the process flow. A database server 100 is provided for storing data related to the status of the various entities and articles of manufacture in the process flow. The database server 100 may store information in one or more data stores 110. The data may include pre-process and post-process metrology data, tool states, lot priorities, operating recipes, etc. The controller 90 may also provide operating recipes to one or more of the tools depicted in FIG. 1. Of course, the controller 90 need not perform all of these functions. Moreover, the functions described for the controller 90 may be performed by one or more computers spread throughout the system 10.

Portions of the invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

The manufacturing system 10 also includes a wafer state metrology calibration unit or controller 12 executing on an illustrative workstation 150. As described more fully below, the wafer state metrology calibration unit or controller 12 may be employed to calibrate one of a plurality of integrated metrology systems on various process tools and/or any of a variety of different stand-alone metrology tools that are adapted to obtain wafer state data. As used herein, the term “calibrate” or “calibrating” shall be understood to include calibrating or matching the integrated metrology system in at least one of the plurality of process tools and/or at least one of the plurality of stand-alone metrology tools based upon the wafer state data acquired for one or more wafers. As described more fully below, the wafer state data may be obtained from a known standard, e.g., a test wafer, and/or from one or more production wafers. The wafer state metrology calibration unit 12 described herein may be used as described herein with any type of tool that is used to perform any type of operation. For example, the wafer state metrology calibration unit 12 may be used as described herein with any of a variety of different process tools, e.g., etch tools, deposition tools, ion implant tools, chemical mechanical polishing (CMP) tools, wet chemical baths (sinks), copper plating tools, furnaces, lithography tracks, exposure tools (scanners or steppers), rapid thermal anneal chambers, etc. Thus, the present invention should not be considered as limited in use to any particular type of tool.

The wafer state metrology calibration unit or controller 12 may communicate with the controller 90 and/or with one or more process controllers 145 associated with the individual tools 30-80 for purposes to be described later herein. The particular control models used by the process controllers 145 depend on the type of tool 30-80 being controlled. The control models may be developed empirically using commonly known linear or non-linear techniques. The control models may be relatively simple equation-based models (e.g., linear, exponential, weighted average, etc.) or a more complex model, such as a neural network model, principal component analysis (PCA) model, partial least squares projection to latent structures (PLS) model. The specific implementation of the control models may vary depending on the modeling techniques selected and the process being controlled. The selection and development of the particular control models would be within the ability of one of ordinary skill in the art, and accordingly, the control models are not described in greater detail herein for clarity and to avoid obscuring the instant invention.

An exemplary information exchange and process control framework suitable for use in the manufacturing system 10 is an Advanced Process Control (APC) framework, such as may be implemented using the Catalyst system formerly offered by KLA-Tencor, Inc. The Catalyst system uses Semiconductor Equipment and Materials International (SEMI) Computer Integrated Manufacturing (CIM) Framework compliant system technologies and is based the Advanced Process Control (APC) Framework. CIM (SEMI E81-0699—Provisional Specification for CIM Framework Domain Architecture) and APC (SEMI E93-0999—Provisional Specification for CIM Framework Advanced Process Control Component) specifications are publicly available from SEMI, which is headquartered in Mountain View, Calif.

The processing and data storage functions are distributed amongst the different computers or workstations in FIG. 1 to provide general independence and central information storage. Of course, different numbers of computers and different arrangements may be used without departing from the spirit and scope of the instant invention.

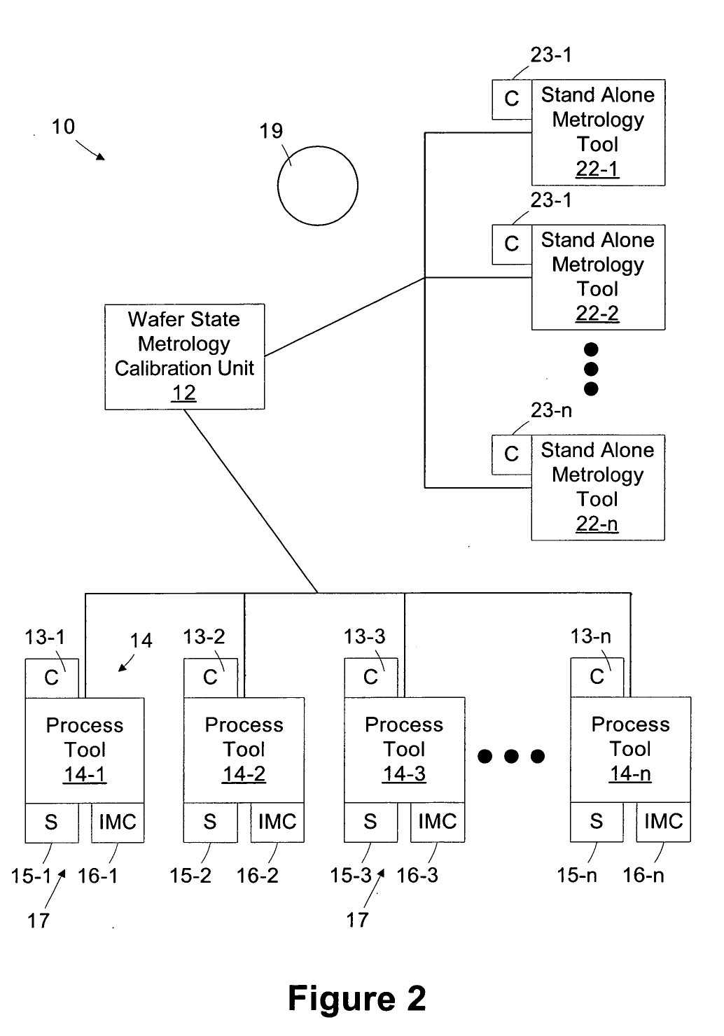

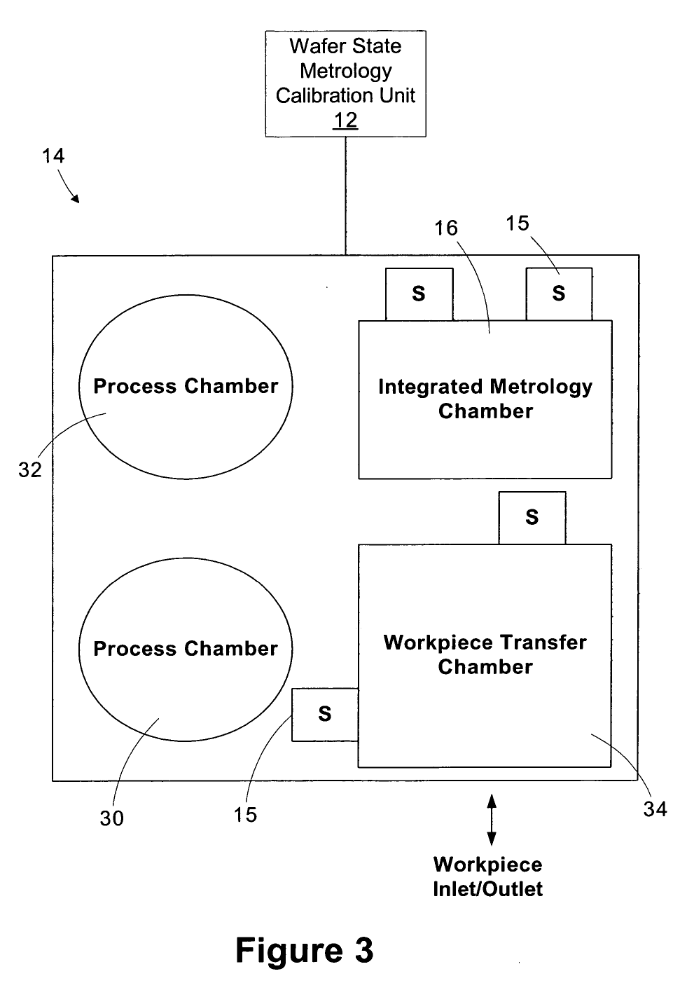

FIG. 2 is a more specific, simplified block diagram of a manufacturing system 10 in accordance with one illustrative embodiment of the present invention. As shown therein, the wafer state metrology calibration unit 12 is operatively coupled to a plurality of process tools 14. In the illustrative embodiment, four such illustrative process tools, 14-1, 14-2, 14-3 and 14-n are schematically depicted. However, the present invention may be employed with any such number of tools. As stated previously, the tools 14 may be any of a variety of different process tools adapted to perform any of a variety of different process operations. In the embodiments depicted in FIGS. 2 and 3, each of the tools 14 comprises an integrated metrology system 17. For example, the integrated metrology system 17 may comprise at least one sensor 15 and/or at least one integrated metrology chamber 16. As used herein, the term integrated metrology system should be understood to include any type of sensor 15 or integrated metrology chamber 16 that is resident on a process tool 14 wherein the sensor 15 and/or metrology chamber 16 are adapted to be used in acquiring wafer state metrology data. Such a sensor 15 or chamber 16 may be part of the original equipment supplied with the process tool 14 or it may be added subsequent to the original manufacture of the process tool 14. In some embodiments, each of the process tools 14 further comprise a local controller 13.

Also depicted in FIG. 2 are a plurality of stand-alone metrology tools 22, e.g., 22-1, 22-2 and 22-n. In the depicted embodiment, each of the stand-alone metrology tools 22 comprises a controller 23. The stand-alone metrology tools 22 may be of any type or configuration. The stand-alone metrology tools 22 are also adapted to obtain wafer state data. As used herein, the term “wafer state data” shall be understood to be any type of metrology data that relates to the physical state or characteristics of a wafer or layers or features formed thereabove or therein. The wafer state data may be obtained from one or more production wafers and/or from one or more test or reference wafers. As indicated above, both the integrated metrology systems 17 resident on the process tools 14 and the stand-alone metrology tools 22 are adapted to acquire wafer state data. Illustrative examples of wafer state data include, but are not limited to, film thickness, critical dimensions of features formed above or in the wafer, surface planarity, surface roughness, wafer temperature, optical properties and/or chemical composition of a film, as well as the quantity, size, and/or type of defects or irregularities found on a wafer, etc. Thus, the present invention should not be considered to be limited to any particular type of metrology data regarding the physical state of the wafer.

Furthermore, the type of sensors 15 employed in obtaining such wafer state data as well as the configuration and location of any integrated metrology chamber 16 may vary depending upon the particular application. FIG. 3 depicts an illustrative example of such a tool 14. In one illustrative embodiment, the integrated metrology chamber 16 may be a separate metrology chamber 16 within a multi-chamber tool 14 comprised of a plurality of process chambers 30, 32. A plurality of sensors 15 are schematically depicted in FIG. 3. Alternatively, the integrated metrology chamber 16 may also simply be a metrology station or a collection of sensors positioned somewhere within the tool 14. In one illustrative embodiment, the integrated metrology system may comprise a plurality of sensors 15 positioned adjacent or within the workpiece transfer station 34 shown in the illustrative process tool 14. Thus, the present invention should not be considered as limited to any particular type of integrated metrology chamber or station or to the configuration or location of any sensors employed in obtaining wafer state data.

As indicated in FIG. 2, the wafer state metrology calibration unit 12 is adapted to receive or have access to wafer state metrology data acquired by both the stand-alone metrology tools 22 and by the integrated metrology systems 17 resident on one or more of the process tools 14. The wafer state metrology calibration unit 12 may take various actions in an effort to calibrate the stand-alone metrology tools 22 and the integrated metrology systems 17 on the process tools 14 based on this wafer state data. To that end, in accordance with one illustrative embodiment of the present invention, a standardized or test wafer 19 may be processed, i.e., subjected to metrology operations, in each of the stand-alone metrology tools 22 and in each of the process tools 14. During the processing of the wafer 19, wafer state metrology data for the wafer 19 is acquired by each of the stand-alone metrology tools 22 and by each of the process tools 14 using the integrated metrology system 17 resident therein. Based upon this collection of wafer state data, the wafer state metrology calibration unit 12 may take various actions. The wafer state data acquired by the integrated metrology systems 17 and/or the stand-alone metrology tools 22 may be in a variety of forms. For example, the wafer state metrology data may be (1) raw trace signatures produced by the metrology hardware and/or (2) modeled (calculated) metrology wafer state output of the integrated metrology system 17 or stand-alone tool 22, e.g., the results, such as layer thickness. The wafer state metrology calibration unit 12 may be a predictive control system in the sense that it may monitor the raw trace data acquired by the integrated metrology systems 17 and/or stand-alone metrology tools 22 to detect when the monitored trace data begins to trend in an undesirable direction. The wafer state metrology calibration unit 12 may also monitor the metrology results, e.g., thickness, planarity, to detect undesirable trends in the wafer state metrology data.

As a specific example, the wafer 19 may have a process layer or film (not shown) formed thereabove, and it is desired to obtain metrology data regarding the thickness of such a layer. To that end, the wafer 19 may be subjected to metrology operations in each of the stand-alone metrology tools 22-1 and 22-2 as well as in each of the integrated metrology systems 17 resident on the process tools 14-1, 14-2 and 14-3. Due to a variety of reasons, the metrology information obtained from each of the metrology resources regarding the thickness of the layer formed on the wafer 19 may vary. For example, the stand-alone metrology tools 22-1 and 22-2 and the integrated metrology systems on the process tools 14-1, 14-2 and 14-3 may obtain thickness readings of, respectively, 80 nm, 100 nm, 100 nm, 100 nm and 70 nm while measuring the same process layer formed on the wafer 19. From this simplistic example, it appears that the metrology data obtained by the stand-alone metrology tool 22-1 (80 nm) and the wafer state data obtained by the integrated metrology system 17 on the process tool 14-3 (70 nm) are inconsistent or “out-of-line” with the wafer state metrology data obtained from the other metrology resources.

In accordance with one aspect of the present invention, the wafer state metrology calibration unit 12 may make adjustments to future metrology readings obtained by the stand-alone metrology tool 22-1 and process tool 14-3 based upon the wafer state data acquired in processing the wafer 19 through each of the stand-alone metrology tools 22 and each of the process tools 14. In one particularly illustrative example, the wafer state metrology calibration unit 12 may send adjustments to the non-conforming or out-of-line metrology resources, e.g., the stand-alone metrology tool 22-1 and the process tool 14-3, to increase light power and/or intensity for optical thickness measurements on future layers. By making this adjustment, the future wafer state data obtained from the stand-alone metrology tool 22-1 and the process tool 14-3 will more accurately reflect the true value of the measured characteristic, e.g., a thickness of 100 nm for the illustrative layer formed above the wafer 19. Other parameters that may be adjusted on the stand-alone metrology tools 22 and/or the integrated metrology systems 17 resident on the process tools 14 include, but are not limited to, extraction voltage, filament current, integration time, lamp intensity, internal calibration, voltage current, detection area, sensitivity, threshold limits, down force, optical filtration, etc.

In accordance with another aspect of the present invention, in making the various calibrations and adjustments described herein, the wafer state metrology calibration unit 12 may treat wafer state data acquired from one of the metrology sources, e.g., one of the stand-alone metrology tools 22 or one of the integrated metrology systems 17 on the process tools 14, as a reference standard. This reference standard of wafer state data may then be used as a basis for comparing the wafer state data obtained from all of the other metrology resources in the system 10 in processing the wafer 19 as described above. That is, after the reference metrology source is identified, the wafer state data acquired in processing the wafer 19 through all of the metrology resources may then be compared to the reference wafer state data obtained by the reference metrology source, i.e., one of the integrated metrology systems 17 or one of the stand-alone metrology tools 22. If a variance exists between the acquired wafer state data for the wafer 19 and the wafer state data acquired by the reference metrology tool, then the wafer state metrology calibration unit or controller 12 may act to calibrate the metrology resources exhibiting such a variance. Identification of the metrology source of the reference wafer state data may involve consideration of a variety of factors. For example, factors such as historical accuracy of data obtained from the metrology resource, the metrology resource having the best mean/median measurement characteristics, the metrology resource exhibiting the smallest standard deviation among various measured values, etc. may be considered in identifying the reference wafer state data to be used by the wafer state metrology calibration unit 12.

As indicated previously, in accordance with one aspect of the present invention, the wafer state metrology calibration unit 12 may be used to calibrate or make various adjustments to one or more of the metrology resources within the system 10. In accordance with another aspect of the present invention, the ability to make such adjustments may be limited by various business rules or constraints established for the system 10. By way of example only, a constraint may be placed on the wafer state metrology calibration unit 12 such that it may not adjust a parameter of the stand-alone metrology tools 22 and/or the integrated metrology systems 17 beyond a pre-established limit or allowable range. The basis for such a business rule may be that, if the wafer state calibration unit 12 determines that an adjustment beyond the allowable range is required, the metrology resource may be in need of substantial maintenance activities to improve the performance of the metrology resource.

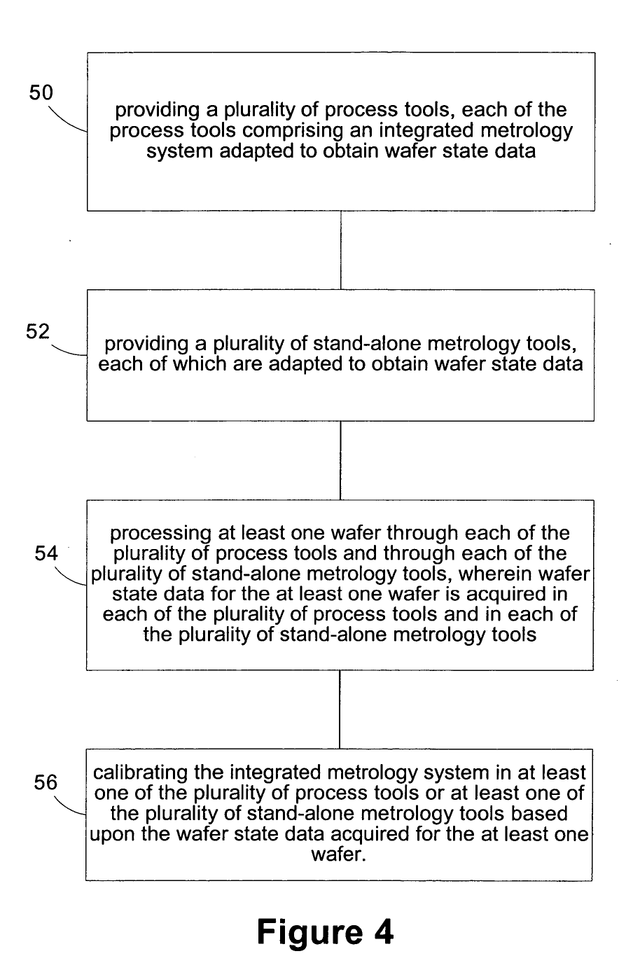

The present invention is generally directed to various methods and systems for calibrating integrated metrology systems and stand-alone metrology systems that acquire wafer state data. One illustrative method is depicted in flowchart form in FIG. 4. As shown therein, in one illustrative embodiment, the method comprises providing a plurality of process tools, each of the process tools comprising an integrated metrology system adapted to obtain wafer state data, as set forth in block 50, and providing a plurality of stand-alone metrology tools, each of which are adapted to obtain wafer state data, as recited in block 52. The method further comprises processing at least one wafer through each of the plurality of process tools and through each of the plurality of stand-alone metrology tools, wherein wafer state data for at least one wafer is acquired in each of the plurality of process tools and in each of the plurality of stand-alone metrology tools, as indicated in block 54, and calibrating the integrated metrology system in at least one of the plurality of process tools or at least one of the plurality of stand-alone metrology tools based upon the wafer state data acquired for the at least one wafer, as set forth in block 56. As used herein, the term “calibrate” or “calibrating” shall be understood to include calibrating or matching the integrated metrology system in at least one of the plurality of process tools or at least one of the plurality of stand-alone metrology tools based upon the wafer state data acquired for the at least one wafer. As indicated previously, the wafer state data may be obtained from a known standard, e.g., a test wafer, and/or from one or more production wafers. In further embodiments, the method comprises processing a plurality of additional wafers through at least one of the plurality of tools 14 and/or stand-alone metrology tools 22 after the step of calibrating the integrated metrology systems and/or stand-alone process tools based upon the acquired wafer state data has been performed.

In another illustrative embodiment, the method comprises providing a plurality of process tools, each of the process tools comprising an integrated metrology system adapted to obtain wafer state data, providing a plurality of stand-alone metrology tools, each of which are adapted to obtain wafer state data, processing at least one wafer through each of the plurality of process tools and through each of the plurality of stand-alone metrology tools, wherein wafer state data for at least one wafer is acquired in each of the plurality of process tools and in each of the plurality of stand-alone metrology tools, and providing a controller adapted to access the wafer state data acquired for the at least one wafer and perform the step of calibrating the integrated metrology system in at least one of the plurality of process tools or at least one of the plurality of stand-alone metrology tools based upon the wafer state data acquired for the at least one wafer.

In yet another illustrative embodiment, the method comprises providing a plurality of process tools, each of the process tools comprising an integrated metrology system adapted to obtain wafer state data, providing a plurality of stand-alone metrology tools, each of which are adapted to obtain wafer state data, providing a controller adapted to identify wafer state data obtained from one of the integrated metrology systems and the stand-alone metrology tools as reference wafer state data, and processing at least one wafer through each of the plurality of process tools and through each of the plurality of stand-alone metrology tools, wherein wafer state data for the at least one wafer is acquired in each of the plurality of process tools and in each of the plurality of stand-alone metrology tools, and wherein the controller is adapted to access the acquired wafer state data and perform the step of calibrating the integrated metrology system in at least one of the plurality of process tools or at least one of the plurality of stand-alone metrology tools based upon a variance between the wafer state data acquired for the at least one wafer and the reference wafer state data.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method, comprising:
providing a plurality of process tools, each of said process tools comprising an integrated metrology system adapted to obtain wafer state data;
providing a plurality of stand-alone metrology tools, each of which are adapted to obtain wafer state data;
processing at least one wafer through each of said plurality of process tools and through each of said plurality of stand-alone metrology tools, wherein wafer state data for said at least one wafer is acquired in each of said plurality of process tools and in each of said plurality of stand-alone metrology tools; and
calibrating said integrated metrology system in at least one of said plurality of process tools or at least one of said plurality of stand-alone metrology tools based upon said wafer state data acquired for said at least one wafer.

2. The method of claim 1, wherein said plurality of process tools comprises at least one of a deposition tool, an etch tool, an ion implant tool, a chemical mechanical polishing tool, a furnace, a rapid thermal anneal chamber, a photolithography track, and an exposure tool.

3. The method of claim 1, wherein said acquired wafer state data for said at least one wafer comprises at least one of a film thickness, a critical dimension of a feature formed on said at least one wafer, a temperature of said wafer, a surface roughness, a surface planarity, an optical property of a film, a chemical composition of a film, a type of defect on said at least one wafer, and a profile of a feature formed on said wafer.

4. The method of claim 1, further comprising a controller that is adapted to access said acquired wafer state data for said at least one wafer and calibrate said integrated metrology system on at least one of said plurality of process tools or at least one of said plurality of stand-alone metrology tools based upon said acquired wafer state data.

5. The method of claim 1, wherein calibrating said integrated metrology system in at least one of said plurality of process tools or at least one of said plurality of stand-alone metrology tools based upon said wafer state data acquired for said at least one wafer comprises determining a correction factor to be applied to future wafer state data acquired by said one of said integrated metrology systems in one of said plurality of process tools or by said stand-alone metrology tool based upon said acquired wafer state data.

6. The method of claim 1, wherein calibrating said integrated metrology system in at least one of said plurality of process tools or at least one of said plurality of stand-alone metrology tools based upon said wafer state data acquired for said at least one wafer comprises:
identifying wafer state data obtained from one of said integrated metrology systems and said stand-alone metrology tools as reference wafer state data; and
calibrating at least one of said integrated metrology systems or one of said stand-alone metrology tools based upon a variance between said wafer state data acquired for said at least one wafer and said reference wafer state data.

7. The method of claim 1, further comprising processing additional wafers through at least one of said process tools and said stand-alone metrology tools.

8. A method, comprising:
providing a plurality of process tools, each of said process tools comprising an integrated metrology system adapted to obtain wafer state data;
providing a plurality of stand-alone metrology tools, each of which are adapted to obtain wafer state data;
processing at least one wafer through each of said plurality of process tools and through each of said plurality of stand-alone metrology tools, wherein wafer state data for said at least one wafer is acquired in each of said plurality of process tools and in each of said plurality of stand-alone metrology tools; and
providing a controller adapted to access said wafer state data acquired for said at least one wafer and perform the step of calibrating said integrated metrology system in at least one of said plurality of process tools or at least one of said plurality of stand-alone metrology tools based upon said wafer state data acquired for said at least one wafer.

9. The method of claim 8, wherein said plurality of process tools comprises at least one of a deposition tool, an etch tool, an ion implant tool, a chemical mechanical polishing tool, a furnace, a rapid thermal anneal chamber, a photolithography track, and an exposure tool.

10. The method of claim 8, wherein said acquired wafer state data for said at least one wafer comprises at least one of a film thickness, a critical dimension of a feature formed on said at least one wafer, a temperature of said wafer, a surface roughness, a surface planarity, an optical property of a film, a chemical composition of a film, a type of defect on said at least one wafer, and a profile of a feature formed on said wafer.

11. The method of claim 8, wherein, in calibrating said integrated metrology system in at least one of said plurality of process tools or at least one of said plurality of stand-alone metrology tools based upon said wafer state data acquired for said at least one wafer, said controller performs the step of determining a correction factor to be applied to future wafer state data acquired by said one of said integrated metrology systems in one of said plurality of process tools or by said stand-alone metrology tool based upon said acquired wafer state data.

12. The method of claim 8, wherein, in calibrating said integrated metrology system in at least one of said plurality of process tools or at least one of said plurality of stand-alone metrology tools based upon said wafer state data acquired for said at least one wafer, said controller performs at least the steps of:
identifying wafer state data obtained from one of said integrated metrology systems and said stand-alone metrology tools as reference wafer state data; and
calibrating at least one of said integrated metrology systems or one of said stand-alone metrology tools based upon a variance between said wafer state data acquired for said at least one wafer and said reference wafer state data.

13. The method of claim 8, further comprising processing additional wafers through at least one of said process tools and said stand-alone metrology tools.

14. A method, comprising:
providing a plurality of process tools, each of said process tools comprising an integrated metrology system adapted to obtain wafer state data;
providing a plurality of stand-alone metrology tools, each of which are adapted to obtain wafer state data;
providing a controller adapted to identify wafer state data obtained from one of said integrated metrology systems and said stand-alone metrology tools as reference wafer state data;
processing at least one wafer through each of said plurality of process tools and through each of said plurality of stand-alone metrology tools, wherein wafer state data for said at least one wafer is acquired in each of said plurality of process tools and in each of said plurality of stand-alone metrology tools; and
wherein said controller is adapted to access said acquired wafer state data and perform the step of calibrating said integrated metrology system in at least one of said plurality of process tools or at least one of said plurality of stand-alone metrology tools based upon a variance between said wafer state data acquired for said at least one wafer and said reference wafer state data.

15. The method of claim 14, wherein said plurality of process tools comprises at least one of a deposition tool, an etch tool, an ion implant tool, a chemical mechanical polishing tool, a furnace, a rapid thermal anneal chamber, a photolithography track, and an exposure tool.

16. The method of claim 14, wherein said acquired wafer state data for said at least one wafer comprises at least one of a film thickness, a critical dimension of a feature formed on said at least one wafer, a temperature of said wafer, a surface roughness, a surface planarity, an optical property of a film, a chemical composition of a film, a type of defect on said at least one wafer, and a profile of a feature formed on said wafer.

17. The method of claim 14, wherein, in calibrating said integrated metrology system in at least one of said plurality of process tools or at least one of said plurality of stand-alone metrology tools, said controller performs the step of determining a correction factor to be applied to future wafer state data acquired by said one of said integrated metrology systems in one of said plurality of process tools or by said stand-alone metrology tool based upon said variance.

18. The method of claim 14, further comprising processing additional wafers through at least one of said process tools and said stand-alone metrology tools.
